(19) United States
(12) Patent Application Publication
(10) Pub. No.: US 2020/0326714 A1
(43) Pub. Date: Oct. 15, 2020

(54) AUTONOMOUS DRIVING VEHICLE MANAGEMENT SYSTEM

(71) Applicant: Toyota Jidosha Kabushiki Kaisha, Toyota-shi Aichi-ken (JP)

(72) Inventors: Takayuki Iwamoto, Sunto-gun (JP); Sho Otaki, Yokohama-shi (JP)

(21) Appl. No.: 16/839,416

(22) Filed: Apr. 3, 2020

(30) Foreign Application Priority Data
Apr. 9, 2019 (JP) 2019-074167

(51) Int. Cl. G05D 1/02; G08G 1/14; G01S 19/42; G01C 21/36

(52) U.S. Cl. CPC G05D 1/0212; G08G 1/141; G05D 2201/0213; G01C 21/3697; G05D 2201/0212; G01S 19/42

(57) ABSTRACT

An autonomous driving vehicle management system is a system for providing a user with an autonomous driving vehicle that is capable of autonomous driving at a plurality of autonomous driving allowable areas respectively associated with a plurality of parking stations. The autonomous driving vehicle management system includes a vacancy situation acquisition unit configured to acquire a vacancy situation at the parking stations, a drop-off available area specifying unit configured to specify a drop-off available area where the autonomous driving vehicle can be dropped off based on the vacancy situation acquired by the vacancy situation acquisition unit and the autonomous driving allowable area, an information providing unit configured to provide the user with information relating to the drop-off available area specified by the drop-off available area specifying unit.

### CROSS-REFERENCE TO RELATED APPLICATIONS

This application claims the benefit of priority from Japanese Patent Application No. 2019-074167, filed on Apr. 9, 2019, the entire contents of which are incorporated herein by reference.

### TECHNICAL FIELD

The present disclosure relates to an autonomous driving vehicle management system.

### BACKGROUND

In the related art, a ride-sharing technology in which an autonomous driving vehicle that is dropped off is autonomously returned to a predetermined return place is known as a technology relating to an autonomous driving vehicle management system (for example, International Patent Publication No. 2015-166811).

### SUMMARY

In the related art described above, for example, if the return place is full, when the autonomous driving vehicle is dropped-off around the return place, the autonomous driving vehicle cannot be parked in the return place. Therefore, there is a problem in that processing for returning the autonomous driving vehicle will be delayed.

According to an aspect of the present disclosure, an autonomous driving vehicle management system is a system for providing a user with an autonomous driving vehicle that is capable of autonomous driving at a plurality of autonomous driving allowable areas respectively associated with a plurality of parking stations. The system includes a vacancy situation acquisition unit configured to acquire a vacancy situation at the parking stations, a drop-off available area specifying unit configured to specify a drop-off available area where the autonomous driving vehicle can be dropped off based on the vacancy situation acquired by the vacancy situation acquisition unit and the autonomous driving allowable area, an information providing unit configured to provide the user with information relating to the drop-off available area specified by the drop-off available area specifying unit.

In the autonomous driving vehicle management system according to an aspect of the present disclosure, the drop-off available area where the autonomous driving vehicle can be dropped off is specified by the drop-off available area specifying unit. The information relating to the specified drop-off available area is provided to the user by the information providing unit. Accordingly, the information relating to the drop-off available area can be provided to the user who is provided with the autonomous driving vehicle. In this way, for example, it is expected that a situation can be suppressed, in which the user who is provided with the autonomous driving vehicle drops off the autonomous driving vehicle at a place other than the drop-off available area.

In an embodiment, the autonomous driving vehicle management system may further include a position recognition unit configured to recognize a vehicle position of the autonomous driving vehicle. The drop-off available area specifying unit may be configured to acquire information on a distance to empty of the autonomous driving vehicle on which the user is riding, and to specify the drop-off available area based on the vacancy situation, the autonomous driving allowable area, the vehicle position, and the information on the distance to empty. In this case, it is possible to provide information relating to the appropriate drop-off available area corresponding to the distance to empty of the autonomous driving vehicle to the user who is provided with the autonomous driving vehicle.

According to the present disclosure, it is possible to provide information relating to a drop-off available area to a user who is provided with the autonomous driving vehicle.

### BRIEF DESCRIPTION OF THE DRAWINGS

FIG. 1 is a diagram illustrating an example of a configuration of an autonomous driving vehicle management system in a first embodiment.

FIG. 2 is a diagram illustrating an example of a plurality of autonomous driving allowable areas.

FIG. 3 is a diagram illustrating an example of a hardware configuration of configuration elements of the autonomous driving vehicle management system.

FIG. 4 is a block diagram illustrating an example of functions of the autonomous driving vehicle management system.

FIG. 5 is a diagram illustrating an example of specifying a drop-off available area.

FIG. 6 is a diagram illustrating an example of displaying the drop-off available area.

FIG. 7 is a flowchart illustrating an operation example of the autonomous driving vehicle management system in FIG. 1.

FIG. 8 is a diagram illustrating an example of a configuration of an autonomous driving vehicle management system in a second embodiment.

FIG. 9 is a flowchart illustrating an operation example of the autonomous driving vehicle management system in FIG. 8.

### DETAILED DESCRIPTION

Hereinafter, exemplary embodiments will be described with reference to the drawings. In the descriptions below, the same reference numerals will be given to the same or equivalent elements, and the descriptions thereof will not be repeated.

### First Embodiment

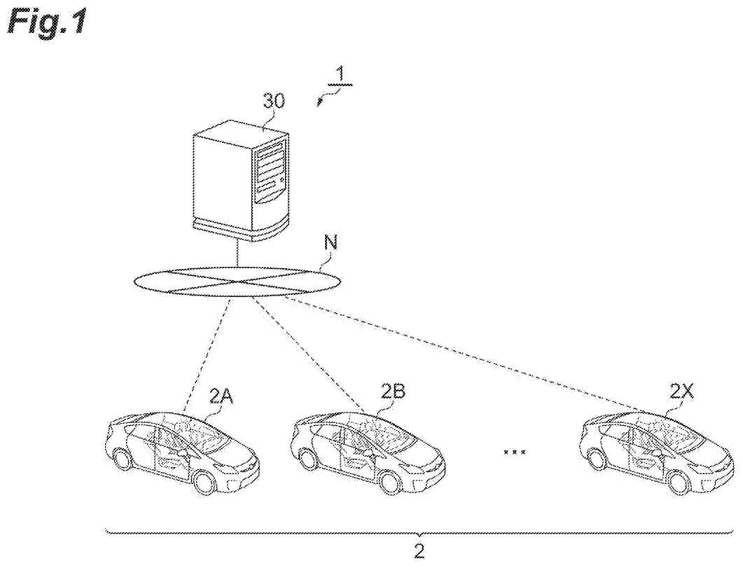

FIG. 1 is a diagram illustrating an example of a configuration of an autonomous driving vehicle management system in a first embodiment. The autonomous driving vehicle management system 1 is a system for providing a user with an autonomous driving vehicle capable of autonomous driving. The user is a user of the autonomous driving vehicle management system 1 that receives provision (vehicle allocation) of the autonomous driving vehicle.

### Overview of Autonomous Driving Vehicle Management System

As illustrated in FIG. 1, the autonomous driving vehicle management system 1 includes a server 30. The server 30 is installed in a facility, for example. The server 30 may be configured with servers or computers provided at a plurality of places. The server 30 is configured to be able to communicate with a plurality of autonomous driving vehicles 2A, 2B, . . . , 2X via a network N. The network N is a wireless communication network.

The autonomous driving vehicles 2A, 2B, . . . , 2X are registered in the autonomous driving vehicle management system 1 in advance. An ID (vehicle identification number) for identifying the vehicle may be assigned to each autonomous driving vehicle 2A, 2B, . . . , 2X. The number of autonomous driving vehicles 2A, 2B, . . . , 2X is not particularly limited. In the descriptions below, the autonomous driving vehicle 2 will be used as the representative of the autonomous driving vehicles 2A, 2B, . . . , 2X.

For example, the autonomous driving vehicle 2 is a vehicle having an autonomous driving function that is a function for the vehicle autonomously travel toward a location set in advance. The autonomous driving vehicle 2 can autonomously travel without a driving operation performed by a user. The autonomous driving vehicle 2 is configured to include various sensors, cameras, actuators, and the like for realizing the autonomous driving function.

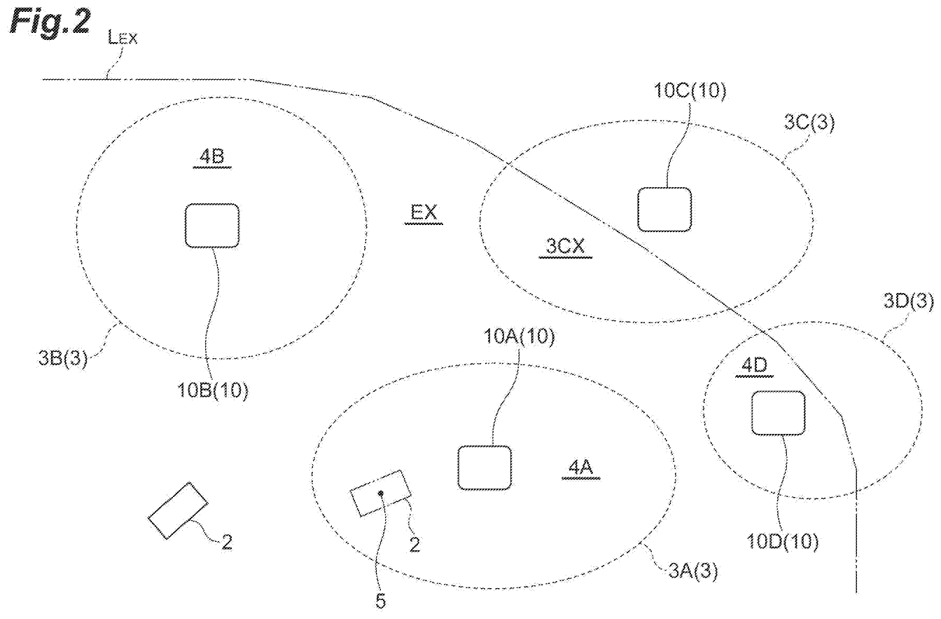

FIG. 2 is a diagram illustrating an example of a plurality of autonomous driving allowable areas. As illustrated in FIG. 2, in the autonomous driving vehicle management system 1, the autonomous driving vehicle 2 is configured to be able to autonomously driving in a plurality of autonomous driving allowable areas 3. As an example, in FIG. 2, the autonomous driving allowable area 3 includes four autonomous driving allowable areas 3A, 3B, 3C, and 3D. The autonomous driving allowable area 3 is an area set in advance in which the autonomous driving vehicle 2 is allowed to travel in the autonomous driving. The autonomous driving allowable area 3 is a range in which an autonomous driving system operates as designed, and is corresponding to an operation range (ODD: operation design domain) of the autonomous driving system. The autonomous driving vehicle 2 is configured to be able to travel in a manual driving outside the autonomous driving allowable area 3.

The plurality of autonomous driving allowable areas 3 are respectively associated with a plurality of parking stations 10. The parking station 10 is a parking facility that functions as a base for allocation and return of the autonomous driving vehicle 2. As an example, in FIG. 2, the parking station 10 includes four parking stations 10A, 10B, 10C, and 10D. In the parking station 10, one or a plurality of autonomous driving vehicles can be parked.

### Hardware Configuration of Autonomous Driving Vehicle Management System

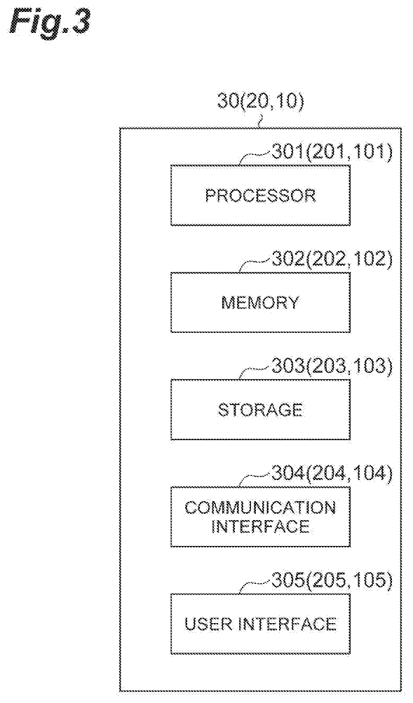

FIG. 3 is a diagram illustrating an example of a hardware configuration of configuration elements of the autonomous driving vehicle management system. As illustrated in FIG. 3, the server 30 can be configured as a general computer including a processor 301, a memory 302, a storage 303, a communication interface 304, and a user interface 305.

The processor 301 is an arithmetic unit such as a central processing unit (CPU). The memory 302 is a storage medium such as read only memory (ROM) or random access memory (RAM). The storage 303 is a storage medium such a hard disk drive (HDD). The communication interface 304 is a communication device that realizes data communication. The user interface 305 is an output device such as a liquid crystal or a speaker, and an input device such as a touch panel or a microphone. The processor 301 performs an overall control of the memory 302, the storage 303, the communication interface 304, and the user interface 305, and realizes the function of the server 30 described later.

The autonomous driving vehicle 2 includes an electronic control unit (ECU) 20. Similarly to the server 30 described above, the ECU 20 includes a processor 201, a memory 202, a storage 203, a communication interface 204, and a user interface 205. The processor 201 performs an overall control of the memory 202, the storage 203, the communication interface 204, and the user interface 205, and realizes the function of the autonomous driving vehicle 2. The autonomous driving vehicle 2 may include a global positioning system (GPS) receiver.

The parking station 10 includes a processing device (for example, a computer) for operating a reservation system in the parking station 10. The processing device in the parking station 10 includes a processor 101, a memory 102, a storage 103, a communication interface 104, and a user interface 105, similarly to the server 30 and ECU 20 described above. The processor 101 performs an overall control of the memory 102, the storage 103, the communication interface 104, and the user interface 105, and realizes the operation of the reservation system.

### Functional Configuration of Autonomous Driving Vehicle Management System

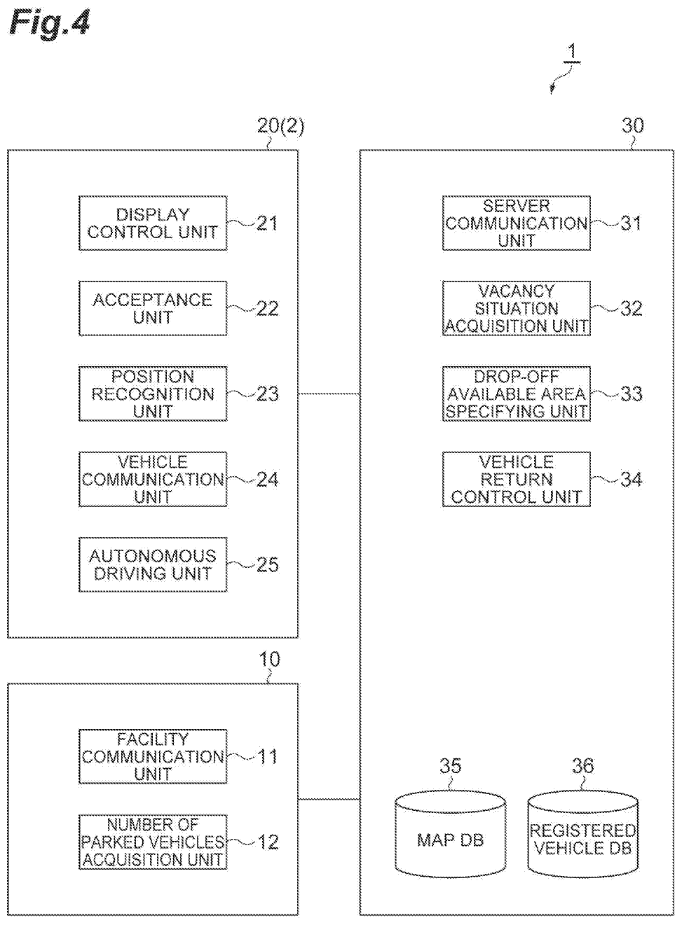

FIG. 4 is a block diagram illustrating an example of functions of the autonomous driving vehicle management system. As illustrated in FIG. 4, the parking station 10 includes a facility communication unit 11 and a number of parked vehicles acquisition unit 12. Each function of the parking station 10 is realized mainly by the processor 101 operating the communication interface 104 or the user interface 105 while referring to the memory 102 and the storage 103.

The facility communication unit 11 manages the communication between the server 30 and the parking station 10. The facility communication unit 11 receives an inquiry about the number of current parked vehicles from the server 30 via the network N. The facility communication unit 11 transmits the number of current parked vehicles to the server 30 via the network N.

If the inquiry about the number of current parked vehicles is received from the server 30 by the facility communication unit 11, the number of parked vehicles acquisition unit 12 acquires the number of current parked vehicles in the parking station 10. The number of current parked vehicles means the number of accommodated vehicles in the parking stations 10 when there is a vehicle return request (described later). The number of parked vehicles acquisition unit 12 can acquire the number of current parked vehicles based on a reservation list in the reservation system of the parking station 10, for example. The reservation list is a time-series list used for a reservation management in the reservation system of the parking station 10, for example. The number of parked vehicles acquisition unit 12 may acquire the number of current parked vehicles based on a result of image analysis of an image captured by the camera provided in the parking station 10.

The number of parked vehicles acquisition unit 12 may acquire the number of current parked vehicles based on information on a position of each vehicle transmitted from autonomous driving vehicles 2 parked at the parking station 10.

The ECU 20 of the autonomous driving vehicle 2 includes a display control unit (information providing unit) 21, an acceptance unit 22, a position recognition unit 23, a vehicle communication unit 24, and an autonomous driving unit 25. Each function of the ECU 20 is realized mainly by the processor 201 operating the communication interface 204 or the user interface 205 while referring to the memory 202 and the storage 203.

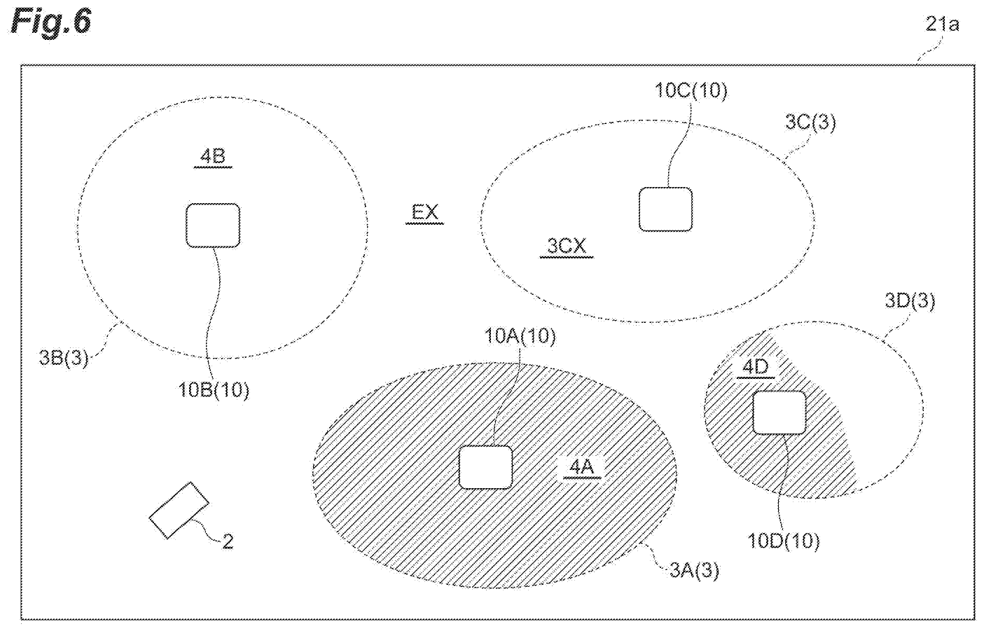

The display control unit 21 performs various displays on a screen of a display 21a of the autonomous driving vehicle 2 (refer to FIG. 6). As the display 21a, for example, a display device (for example, a touch panel display or the like of a car navigation system) of a human machine interface (HMI) provided on the autonomous driving vehicle 2 can be used. The display control unit 21 performs display for the user to make a vehicle return request. The display control unit 21 performs a display for providing the user with the information relating to a drop-off available area (described later). The display control unit 21 may perform the display for the user to apply for a drop-off reservation (described later).

The acceptance unit 22 accepts an operation by a user who is riding on the autonomous driving vehicle 2. As the display control unit 21, for example, an HMI input unit (for example, a touch panel display or a button of a car navigation device) provided in the autonomous driving vehicle 2 can be used. The acceptance unit 22 recognizes the user operation by accepting the touch input by the user to the input unit. The user operation may be a button operation by the user. The user operation includes, for example, an operation for the user to make a vehicle return request. The user operation may include an operation for the user to select a drop-off available area. The user operation may include an operation for the user to make a drop-off reservation application.

The position recognition unit 23 acquires the position of the autonomous driving vehicle 2 on a map based on position information from the vehicle-mounted GPS receiver and map information.

The vehicle communication unit 24 manages the communication of the autonomous driving vehicle 2. The vehicle communication unit 24 communicates with the autonomous driving vehicle 2 and the server 30 by being connected to the network N. The vehicle communication unit 24 transmits the information relating to the user operation and the information on the vehicle position of the autonomous driving vehicle 2 to the server 30 via the network N. The vehicle communication unit 24 receives the information relating to the drop-off available area from the server 30 via the network N. The vehicle communication unit 24 may transmit information on a distance to empty (described later) of the autonomous driving vehicle 2 to the server 30 via the network N.

The autonomous driving unit 25 performs the autonomous driving of the autonomous driving vehicle 2. The autonomous driving unit 25 performs the autonomous driving by controlling various actuators (for example, an engine actuator, a brake actuator, and a steering actuator) of the autonomous driving vehicle 2. If a location other than the autonomous driving allowable area 3 is set by the user, the autonomous driving unit 25 may not perform the autonomous driving.

The autonomous driving unit 25 generates the information on the distance to empty of the autonomous driving vehicle 2. The information on the distance to empty is information on the distance to empty of the autonomous driving vehicle 2. The autonomous driving unit 25 can calculate the distance to empty using a known method based on a remaining amount of energy (for example, an amount of charged electricity or a remaining amount of fuel) for the autonomous driving vehicle 2 to travel. The autonomous driving unit 25 may estimate the distance to empty based on a travel plan of the autonomous driving vehicle 2 from the vehicle return location 5 (described later, referred to FIG. 2) when the parking station 10 is set as a destination. The autonomous driving unit 25 may estimate the distance to empty based on a travel distance from the previous refueling of the autonomous driving vehicle 2 or the like. If an inquiry about the information on the distance to empty from the server 30 is received by the vehicle communication unit 24, the autonomous driving unit 25 transmits the information on the distance to empty to the server 30 via the vehicle communication unit 24.

Next, the server 30 manages the vehicle return of the autonomous driving vehicle 2. The server 30 manages the vehicle return of a user's autonomous driving vehicle 2 based on the vehicle return request from the user who is provided with the autonomous driving vehicle 2. The function of the server 30 is realized mainly by the processor 301 operating the communication interface 304 or the user interface 305 while referring to the memory 302 and the storage 303. The server 30 includes a server communication unit 31, a vacancy situation acquisition unit 32, a drop-off available area specifying unit 33, a vehicle return control unit 34, a map DB 35, and a registered vehicle DB 36.

The server communication unit 31 manages the communication between the autonomous driving vehicle 2 and the server 30. The server communication unit 31 manages the communication between the parking station 10 and the server 30. The server communication unit 31 receives a vehicle return request from the user, from the autonomous driving vehicle 2 via the network N. The vehicle return request means a request by the user to drop off the autonomous driving vehicle 2 to return the vehicle. For example, information in which at least an ID of the autonomous driving vehicle 2 provided to the user and a user's scheduled time of dropping off the autonomous driving vehicle 2 are associated with each other can be defined as the vehicle return request. A timing at which the vehicle return request can be made may be before the autonomous driving vehicle 2 is provided to the user, or may be during a period when the user who is provided with the autonomous driving vehicle 2 is riding on the autonomous driving vehicle 2.

The server communication unit 31 may acquire various information (the information on the vehicle position, the information on the distance to empty, a result of detection performed by the sensor, and the like) on the autonomous driving vehicle 2 from the autonomous driving vehicle 2.

If the vehicle return request from the user is received by the server communication unit 31, the vacancy situation acquisition unit 32 acquires a vacancy situation of the plurality of parking stations 10. The vacancy situation means the number of vacancies in the parking station 10 when the vehicle return request is made. The number of vacancies is the number of autonomous driving vehicles 2 that can be accommodated in the parking station 10 when the vehicle return request is made.

The vacancy situation acquisition unit 32 can calculate the number of vacancies based on, for example, the upper limit number of vehicles that can be accommodated in the parking stations 10 and the number of current parked vehicles when the vehicle return request is made. For example, if the vehicle return request from the user is received by the server communication unit 31, the vacancy situation acquisition unit 32 transmits an inquiry about the number of current parked vehicles to the parking station 10 via the server communication unit 31. The vacancy situation acquisition unit 32 acquires the vacancy situation of the parking station 10 using the number of current parked vehicles received from the parking station 10.

The upper limit number means a number of the autonomous driving vehicles 2 set in advance depending on the accommodation ability of the parking station 10. The vacancy situation acquisition unit 32 acquires the upper limit number from, for example, the map DB 35 described later. Alternatively, the vacancy situation acquisition unit 32 may receive the upper limit number from the parking station 10 via the network N.

Here, “when the vehicle return request is made” may be a time point when the user transmits the vehicle return request, may be a time point when the server 30 receives the vehicle return request, may be a time point when the server 30 transmits an inquiry about the number of current parked vehicles to the parking station 10, or may be a time point when the parking station 10 receives the inquiry about the number of current parked vehicles.

The vacancy situation acquisition unit 32 may calculate the number of vacancies based on the number of parking reservations in the parking station 10 when the vehicle return request is made, in addition to the above-described upper limit number and the number of current parked vehicles. The number of parking reservations is the number of autonomous driving vehicles 2 that are not accommodated in the parking station 10 when the vehicle return request is made, but are scheduled to be accommodated in the parking station 10 later. The number of parking reservations may be included in the reservation list stored in a storage unit of the parking station 10. The number of vacancies may not necessarily need to be calculated while taking the number of parking reservations into consideration.

The drop-off available area specifying unit 33 specifies a drop-off available area based on the vacancy situation and the autonomous driving allowable area 3. The drop-off available area is an area where the autonomous driving vehicle 2 can be dropped off. Each of the plurality of autonomous driving allowable areas 3 can be specified as the drop-off available area. For example, the drop-off available area specifying unit 33 specifies an autonomous driving allowable area 3 that is associated with the parking station 10 having the vacancy situation in which the number of vacancies is equal to or more than one as a candidate for the drop-off available area.

The drop-off available area specifying unit 33 may specify the drop-off available area based on, for example, the vacancy situation, the autonomous driving allowable area 3, the vehicle position, and the information on the distance to empty of the autonomous driving vehicle 2. For example, if the vehicle return request from the user is received, the drop-off available area specifying unit 33 transmits an inquiry about the information on the distance to empty, to the autonomous driving vehicle 2 via the server communication unit 31. The drop-off available area specifying unit 33 acquires the information on the distance to empty, from the autonomous driving vehicle 2.

The drop-off available area specifying unit 33 specifies, for example, candidate for the drop-off available area of which the parking station 10 is within the range of the distance to empty of the autonomous driving vehicle 2 as the drop-off available area. The range here means a range on the map representing the spread of the area. Here, as a specific example, an area EX on the autonomous driving vehicle 2 side from a two-dot chain line L_{EX} in FIG. 2 corresponds to within the range of the distance to empty.

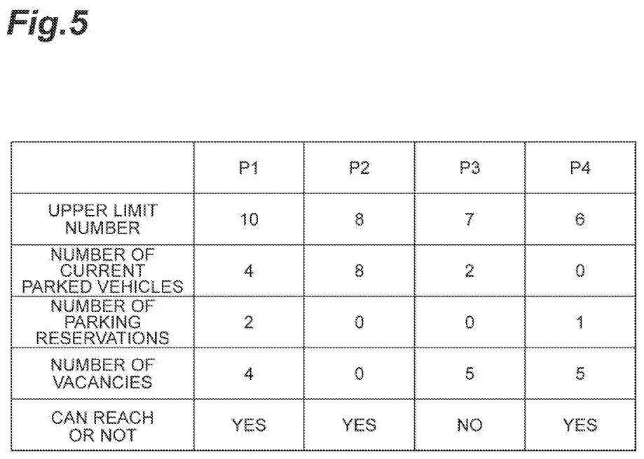

FIG. 5 is a diagram illustrating an example of specifying the drop-off available area. In the example in FIG. 5, each of P1, P2, P3, and P4 in a table are respectively corresponding to the information about the parking stations 10A, 10B, 10C, and 10D when the parking station 10 receives the inquiry about the number of current parked vehicles from the server 30. As illustrated in FIG. 2 and FIG. 5, the drop-off available area specifying unit 33 may specify the drop-off available area by determining whether or not the autonomous driving vehicle 2 dropped off in the vehicle return location 5 can reach the parking station 10 based on the number of vacancies and the information on the distance to empty. The vehicle return location 5 is a location within the autonomous driving allowable area 3, where the autonomous driving vehicle 2 becomes able to be returned to the parking station 10 after the user who is provided with the autonomous driving vehicle 2 finishes to use the autonomous driving vehicle 2.

As an example, regarding the parking station 10A, the upper limit number is 10, the number of current parked vehicles is 4, and the number of parking reservations is 2, therefore, the number of vacancies is 4. Accordingly, the drop-off available area specifying unit 33 specifies the autonomous driving allowable area 3A associated with the parking station 10A as the candidate for the drop-off available area. In addition, the autonomous driving vehicle 2 can reach the parking station 10A from any location in the area 4A corresponding to the entire area of the autonomous driving allowable area 3A. Therefore, the drop-off available area specifying unit 33 specifies the area 4A as the drop-off available area.

Regarding the parking station 10B, the autonomous driving vehicle 2 can reach the parking station 10B from any location in the area 4B corresponding to the entire area of the autonomous driving allowable area 3B associated with the parking station 10B. However, in parking station 10B, the upper limit number is 8 and the number of current parked vehicles is 8, therefore, the number of vacancies is 0. Therefore, the drop-off available area specifying unit 33 does not specify the area 4B as the candidate for the drop-off available area.

Regarding the parking station 10C, the upper limit number is 7, the number of current parked vehicles is 2, and the number of parking reservations is 0, therefore, the number of vacancies is 5. Accordingly, the drop-off available area specifying unit 33 specifies the autonomous driving allowable area 3C associated with the parking station 10C as the candidate for the drop-off available area. However, the autonomous driving vehicle 2 cannot reach the parking station 10C from any location in the area 3CX corresponding to the set of locations to which the autonomous driving vehicle 2 can reach among the autonomous driving allowable area 3C. Therefore, the drop-off available area specifying unit 33 does not specify the area 3CX as the drop-off available area.

Regarding the parking station 10D, the upper limit number is 6, the number of current parked vehicles is 0, and the number of parking reservations is 1, therefore, the number of vacancies is 5. Accordingly, the drop-off available area specifying unit 33 specifies the autonomous driving allowable area 3D associated with the parking station 10D as the candidate for the drop-off available area. In addition, the autonomous driving vehicle 2 can reach the parking station 10D from any location in the area 4D corresponding to the set of locations to which the autonomous driving vehicle 2 can reach among the autonomous driving allowable area 3D. Therefore, the drop-off available area specifying unit 33 specifies the area 4D as the drop-off available area.

The drop-off available area specifying unit 33 provides the user with the information relating to the specified drop-off available area. The drop-off available area specifying unit 33 transmits the information relating to the drop-off available area to the autonomous driving vehicle 2 that has transmitted the vehicle return request, via the server communication unit 31. For example, image data of the drop-off available area which can be displayed on the display control unit 21 may be the information relating to the drop-off available area. The drop-off available area specifying unit 33 provides the user with the information relating to the drop-off available area by, for example, displaying an image in which the drop-off available area is indicated on the map, on the display control unit 21.

FIG. 6 is a diagram illustrating an example of displaying the drop-off available area. As illustrated in FIG. 6, the display control unit 21 may display an image such as indicating the autonomous driving allowable areas 3A, 3B, 3C, and 3D in a similar positional relationship to that in FIG. 5 and indicating the areas 4A and 4D (hatched portions in FIG. 6) as the drop-off available areas, on the display 21a. Since FIG. 6 is a schematic diagram for explaining the example of the image, for example, instead of the reference numerals in the drawing, a description that makes the user understand the content such as the autonomous driving allowable area 3 may be displayed on the display 21a.

In the examples in FIG. 2 and FIG. 5, for example, among a plurality of specified drop-off available areas (the areas 4A and 4D), the drop-off available area specifying unit 33 may display the image in which the area having greater number of vacancies (the area 4D) is emphasized, on the display control unit 21. Alternatively, for example, among the plurality of specified drop-off available areas (the areas 4A and 4D), the drop-off available area specifying unit 33 may display the image in which the area having a shorter distance from the autonomous driving vehicle 2 (the area 4A) is emphasized, on the display control unit 21.

The drop-off available area is an area where parking or stopping of the autonomous driving vehicle 2 is not legally prohibited. The drop-off available area is, for example, a parking lot. The drop-off available area may be a parking section for parking and stopping of the autonomous driving vehicle 2 provided in the parking lot. The drop-off available area may be a parking lot of a store such as a convenience store. The drop-off available area may be a parking lot such as a parking area provided on a dedicated automobile road. The drop-off available area may be a location on the road or an area of a certain range in the parking lot. The drop-off available area may be an area extending along the road.

The vehicle return control unit 34 controls a vehicle return (return) of the autonomous driving vehicle 2 that has been dropped off. The vehicle return control unit 34 accepts, for example, a drop-off reservation application from the user who is provided with the information relating to the drop-off available area. The drop-off reservation application means a prior application to the server 30 for the drop-off of the autonomous driving vehicle 2, the prior application made by the user who is provided with the information relating to the drop-off available area. The vehicle return control unit 34 may cause the user who is provided with the information relating to the drop-off available area to accept the drop-off reservation application.

The drop-off reservation application may include the information on a scheduled vehicle return location scheduled to be the vehicle return location 5. The scheduled vehicle return location means, for example, a location where the user has finished to use or schedule to finish to use the autonomous driving vehicle 2 within the drop-off available area of which the information is provided to the user. The scheduled vehicle return location is expected to be the location selected with reference to the information relating to the drop-off available area provided to the user.

Specifically, the scheduled vehicle return location may be a location within the autonomous driving allowable area 3 that is set by the user who is provided with and is riding on the autonomous driving vehicle 2 during riding, as a destination for the autonomous driving. The scheduled vehicle return location may be a location within the autonomous driving allowable area 3 where the user who is provided with and is riding on the autonomous driving vehicle 2 performs an operation for stopping the autonomous driving vehicle 2 and finishing the autonomous driving. The scheduled vehicle return location may be a location within the autonomous driving allowable area 3 where the user who is provided with and is riding on the autonomous driving vehicle 2 stops the autonomous driving vehicle 2 and gets off the autonomous driving vehicle 2.

If the information on the scheduled vehicle return location is included in the drop-off reservation application, the vehicle return control unit 34 may recognize the scheduled vehicle return location as the vehicle return location 5 and may cause the autonomous driving unit 25 to perform the autonomous driving after the drop-off.

The user who is provided with the information relating to the drop-off available area may not necessarily apply for the drop-off reservation. That is, the user who is provided with the information relating to the drop-off available area may drop off the autonomous driving vehicle 2 in the drop-off available area referring to the provided information, without applying for the drop-off reservation. In this case, the autonomous driving vehicle 2 may transmit information indicating that the user has dropped off the autonomous driving vehicle 2 within the drop-off available area and information on the vehicle position at the drop-off location, to the server 30 via the vehicle communication unit 24 and the network N. If the information indicating that the user has dropped off the autonomous driving vehicle 2 within the drop-off available area is received by the server communication unit 31, the vehicle return control unit 34 recognizes the drop-off location as the vehicle return location 5.

If the drop-off reservation application from the user is received, or if the information indicating that the user has dropped off the autonomous driving vehicle 2 within the drop-off available area is received by the server communication unit 31, the vehicle return control unit 34 updates the reservation list of the parking station 10. As vehicle return processing for the autonomous driving vehicle 2, the vehicle return control unit 34 causes the autonomous driving vehicle 2 dropped off in the autonomous driving allowable area 3 to move from the vehicle return location 5 to the parking station 10 associated with the autonomous driving allowable area 3 by autonomous driving.

The map DB 35 is a database that stores the map information. The map DB 35 is stored in the storage 303 of the server 30, for example. The map information is data storing the information on the position of the roads, road structures, buildings, and the like. The information on the position and range of the autonomous driving allowable area 3 on the map, the position information of each parking station 10, and the information on the above-described upper limit number of each parking station 10 may be included in the map information. The registered vehicle DB 36 is stored in the storage 303 of the server 30, for example. The registered vehicle DB 36 stores, for example, the ID of each autonomous driving vehicle 2, the information on the vehicle position of each autonomous driving vehicle 2, and the travel plan of each autonomous driving vehicle 2 in association with each other.

### Processing by Autonomous Driving Vehicle Management System 1

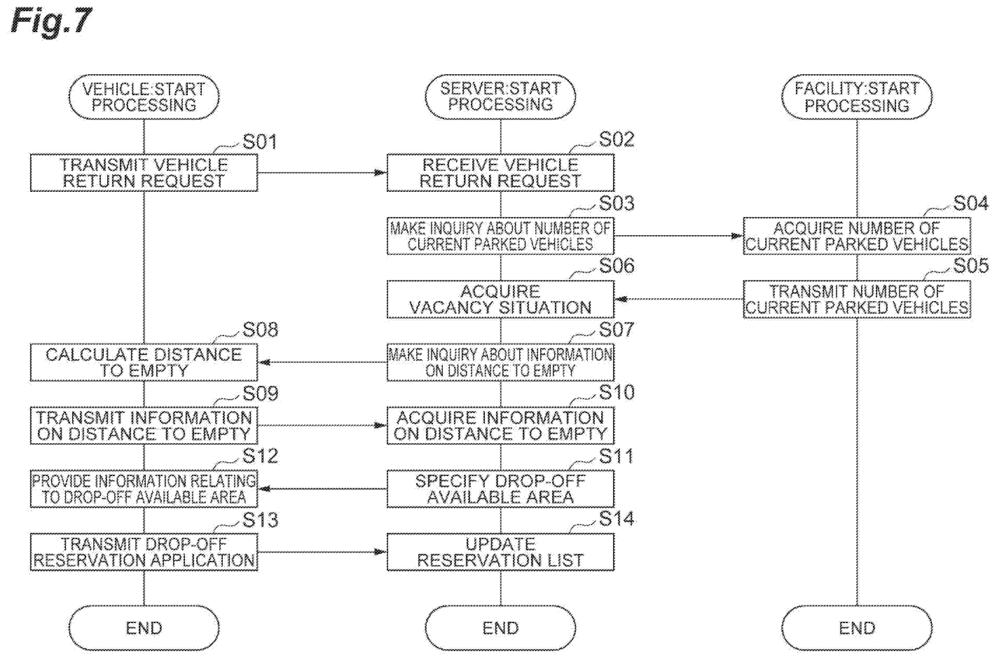

Next, processing by the autonomous driving vehicle management system 1 according to the present embodiment will be described with reference to the drawings. FIG. 7 is a flowchart illustrating an operation example of the autonomous driving vehicle management system 1 in FIG. 1. As an example, the processing in FIG. 7 is performed when the vehicle return request is made from the user who is provided with and is riding on the autonomous driving vehicle 2.

As illustrated in FIG. 7, in S01, the autonomous driving vehicle 2 transmits the vehicle return request from the user to the server 30 using the vehicle communication unit 24. In S02, the server 30 receives the vehicle return request from the user using the server communication unit 31.

In S03, the server 30 makes an inquiry about the number of current parked vehicles to the parking station 10 using the vacancy situation acquisition unit 32. In S04, the parking station 10 receives the inquiry about the number of current parked vehicles using the facility communication unit 11, and acquires the number of current parked vehicles using the number of parked vehicles acquisition unit 12. In S05, the parking station 10 transmits the number of current parked vehicles to the server 30 using the facility communication unit 11. In S06, the server 30 acquires the vacancy situation using the vacancy situation acquisition unit 32, for example, based on the upper limit number, the number of current parked vehicles, and the number of parking reservations in the parking station 10.

In S07, the server 30 makes an inquiry about the information on the distance to empty to the autonomous driving vehicle 2 using the drop-off available area specifying unit 33. In S08, the autonomous driving vehicle 2 calculates the distance to empty using the autonomous driving unit 25. In S09, the autonomous driving vehicle 2 transmits the information on the distance to empty to the server 30 using the vehicle communication unit 24. In S10, the server 30 acquires the information on the distance to empty using the server communication unit 31. In S11, the server 30 specifies the drop-off available area using the drop-off available area specifying unit 33, and transmits the information relating to the drop-off available area to the autonomous driving vehicle 2 using the server communication unit 31.

In S12, the autonomous driving vehicle 2 receives the information relating to the drop-off available area using the vehicle communication unit 24, and provides the information relating to the drop-off available area to the user using the display control unit 21. In S13, the autonomous driving vehicle 2 accepts the drop-off reservation application from the user using the acceptance unit 22 and transmits the drop-off reservation application to the server 30 using the vehicle communication unit 24. In S14, the server 30 receives the drop-off reservation application using the server communication unit 31, and updates the reservation list and performs the vehicle return processing for the autonomous driving vehicle 2 using the vehicle return control unit 34. Thereafter, the processing in FIG. 7 is ended.

According to the autonomous driving vehicle management system 1 in the present embodiment described above, a drop-off available area where the autonomous driving vehicle 2 can be dropped off is specified by the drop-off available area specifying unit 33. The information relating to the specified drop-off available area is provided to the user by the display control unit 21. Accordingly, it is possible to provide the information relating to the drop-off available area to the user who is provided with the autonomous driving vehicle 2. In this way, for example, it is expected that a situation can be suppressed, in which the user who is provided with the autonomous driving vehicle 2 drops off the autonomous driving vehicle 2 at a place other than the drop-off available area. As a result thereof, it is expected that the processing for returning the autonomous driving vehicle 2 is smoothly performed.

The autonomous driving vehicle management system 1 further includes a position recognition unit 23 that recognizes the vehicle position of the autonomous driving vehicle 2. The drop-off available area specifying unit 33 may obtain the information on the distance to empty of the autonomous driving vehicle 2 on which the user is riding, and may specify the drop-off available area based on the vacancy situation, the autonomous driving allowable area, the vehicle position, and the information on the distance to empty. In this case, it is possible to provide appropriate information relating to the drop-off available area corresponding to the distance to empty of the autonomous driving vehicle 2 to the user who is provided with the autonomous driving vehicle 2.

### Second Embodiment

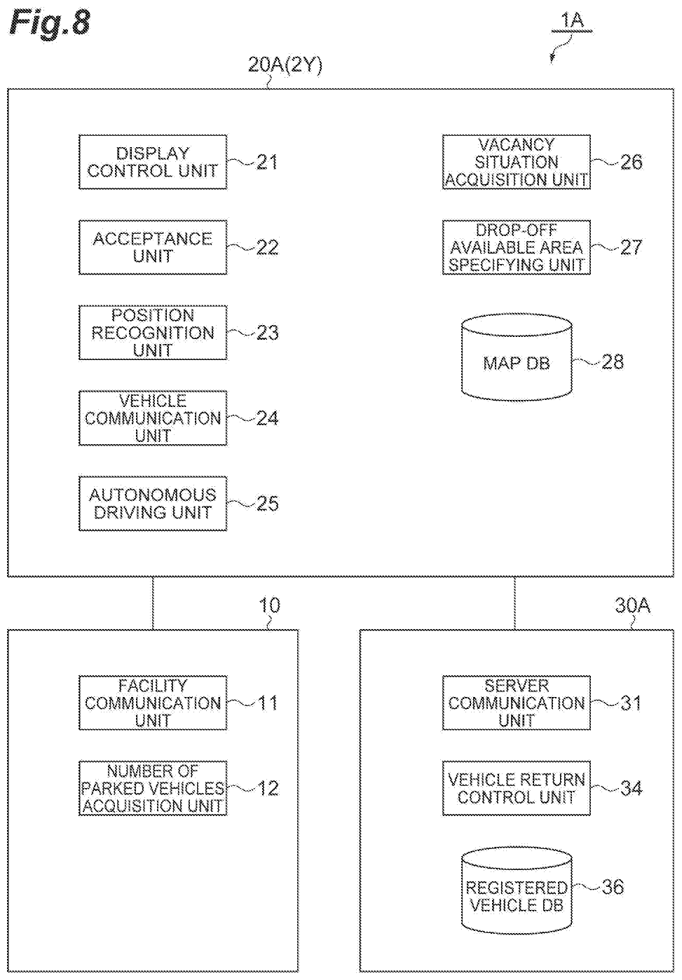

FIG. 8 is a diagram illustrating an example of a configuration of an autonomous driving vehicle management system in a second embodiment. The autonomous driving vehicle management system 1A in the second embodiment is different from the autonomous driving vehicle management system 1 in the first embodiment in a point that a part of the functions included in the server 30 is included in an ECU 20A of the autonomous driving vehicle 2Y.

As illustrated in FIG. 8, the ECU 20A is different from the ECU 20 in a point that the ECU 20A further includes a vacancy situation acquisition unit 26, a drop-off available area specifying unit 27, and a map DB 28.

The vacancy situation acquisition unit 26 has basically the same function as the vacancy situation acquisition unit 32 in the first embodiment. As a difference, the vacancy situation acquisition unit 26 acquires vacancy situations of a plurality of parking stations 10 when a vehicle return request from the user is accepted by the acceptance unit 22.

For example, when the vehicle return request from the user is accepted by the acceptance unit 22, the vacancy situation acquisition unit 26 transmits an inquiry about the number of current parked vehicles to the parking station 10 via the vehicle communication unit 24. The vacancy situation acquisition unit 26 acquires the vacancy situation of the parking station 10 using the number of current parked vehicles received from the parking station 10. Alternatively, the vacancy situation acquisition unit 26 may acquire the number of current parked vehicles in the parking station 10 by, for example, a vehicle-to-vehicle communication with another autonomous driving vehicle 2 parked in the parking station 10.

The vacancy situation acquisition unit 26 acquires the upper limit number from the map DB 28, for example. Alternatively, the vacancy situation acquisition unit 26 may receive the upper limit number from the parking station 10 via the network N, or the vacancy situation acquisition unit 26 may store the upper limit number in advance.

Here, “when the vehicle return request is made” may be a time point when the vehicle return request from the user is accepted by the acceptance unit 22, may be a time point when the autonomous driving vehicle 2Y transmits the inquiry about the number of current parked vehicles to the parking station 10, or may be a time point when the parking station 10 receives the inquiry about the number of current parked vehicles.

The drop-off available area specifying unit 27 has basically the same function as the drop-off available area specifying unit 33 in the first embodiment. For example, when the vehicle return request from the user is accepted by the acceptance unit 22, the drop-off available area specifying unit 27 acquires the information on the distance to empty generated by the autonomous driving unit 25 as described above.

The drop-off available area specifying unit 27 controls the display control unit 21 to provide the user with the information relating to the specified drop-off available area. The drop-off available area specifying unit 27 may control the display control unit 21 such that, for example, the image in FIG. 6 is displayed on the display 21a.

The map DB 28 stores information same as that in the map DB 35. The map DB 28 may store map information for the autonomous driving that is used for the autonomous driving vehicle 2Y to travel in the autonomous driving.

The server 30A is different from the server 30 in the first embodiment in a point that a part of the functional configurations that is moved to the ECU 20A of the autonomous driving vehicle 2Y is not included in the server 30A. The server 30A includes a server communication unit 31, a vehicle return control unit 34, and a registered vehicle DB 36, which are the remaining functional configurations, and those functions are basically the same as the functions in the first embodiment.

### Processing by Autonomous Driving Vehicle Management System 1A

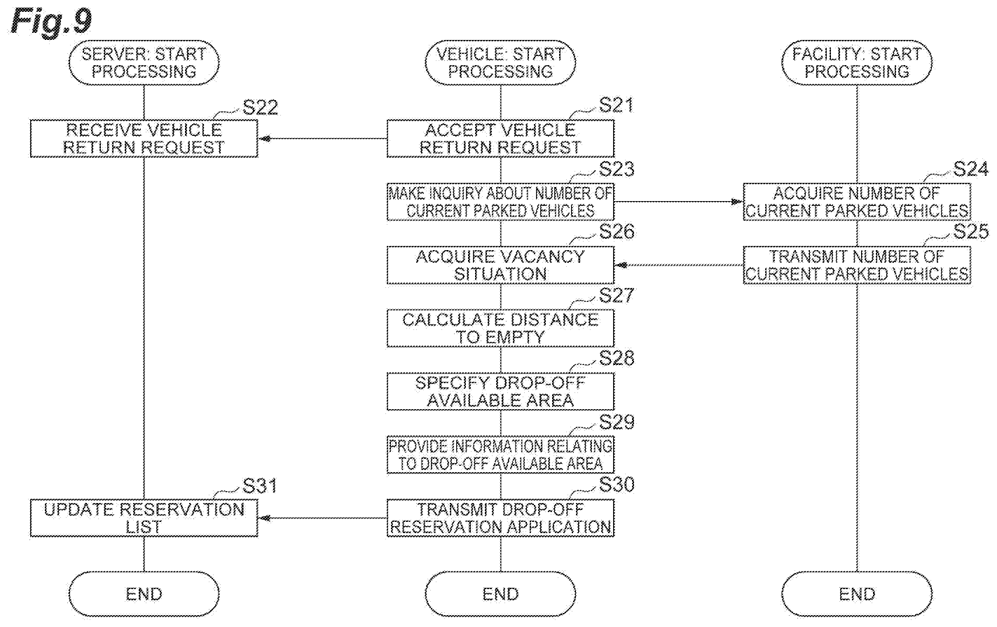

Next, the processing by the autonomous driving vehicle management system 1A in the present embodiment will be described with reference to the drawings. FIG. 9 is a flowchart illustrating an operation example of the autonomous driving vehicle management system 1A in FIG. 8. As an example, the processing in FIG. 9 is performed when the vehicle return request is made from the user who is provided with and is riding on the autonomous driving vehicle 2.

As illustrated in FIG. 9, in S21, the autonomous driving vehicle 2Y accepts the vehicle return request from the user using the acceptance unit 22, and transmits the information indicating that the vehicle return request from the user is accepted, to the server 30A using the vehicle communication unit 24. In S22, the server 30A receives the information indicating that the vehicle return request from the user is accepted, using the server communication unit 31. In the server 30A, for example, the information may be used as a trigger for the vehicle return processing.

In S23, the autonomous driving vehicle 2Y makes the inquiry about the number of current parked vehicles to the parking station 10 using the vacancy situation acquisition unit 26. In S24, the parking station 10 receives the inquiry about the number of current parked vehicles using the facility communication unit 11, and acquires the number of current parked vehicles using the number of parked vehicles acquisition unit 12. In S25, the parking station 10 transmits the number of current parked vehicles to the autonomous driving vehicle 2Y using the facility communication unit 11. In S26, the autonomous driving vehicle 2Y acquires the vacancy situation based on, for example, the upper limit number, the number of current parked vehicles, and the number of parking reservations of the parking station 10 using the vacancy situation acquisition unit 26.

In S27, the autonomous driving vehicle 2Y calculates or estimates the distance to empty using the autonomous driving unit 25 and acquires the information on the distance to empty using the drop-off available area specifying unit 27. In S28, the autonomous driving vehicle 2Y specifies the drop-off available area using the drop-off available area specifying unit 27.

In S29, the autonomous driving vehicle 2Y provides the user with the information relating to the drop-off available area using the display control unit 21. In S30, the autonomous driving vehicle 2Y accepts the drop-off reservation application from the user using the acceptance unit 22, and transmits the drop-off reservation application to the server 30A using the vehicle communication unit 24. In S31, the server 30A receives the drop-off reservation application using the server communication unit 31, and updates the reservation list and performs the vehicle return processing for the autonomous driving vehicle 2 using the vehicle return control unit 34. Thereafter, the processing in FIG. 9 is ended.

According to the autonomous driving vehicle management system 1A in the second embodiment described above, the same operation effects as the autonomous driving vehicle management system 1 in the first embodiment can be obtained. In addition, according to the autonomous driving vehicle management system 1A in the second embodiment, since a part of the functions of the server 30 in the first embodiment are included in the ECU 20A of the autonomous driving vehicle 2Y, an influence due to the communication status of the network N becomes less.

### Modification Example

As described above, embodiments of the present disclosure are described, however, the present disclosure is not limited to each embodiment described above. The present disclosure can be embodied in various forms including various modifications and improvements based on the knowledge of those skilled in the art including the above-described embodiments.

For example, at least one of the functional configurations of the servers 30 and 30A may be provided on the cloud server.

For example, the server 30 or the autonomous driving vehicle 2Y may not necessarily need to specify the drop-off available area using the information on the distance to empty. In this case, the server 30 or the autonomous driving vehicle 2Y may specify the autonomous driving allowable area 3 (in the example in FIG. 5, the autonomous driving allowable areas 3A, 3C, and 3D) that is associated with the parking station 10 having the vacancy situation in which the number of vacancies is equal to or more than one, as the drop-off available area.

For example, the user may perform the input operation for the vehicle return request and the drop-off reservation application using a mobile communication terminal such as a personal computer, a tablet, or a smartphone instead of the acceptance unit 22 of the autonomous driving vehicle 2 or 2Y. In this case, the position information on the position of the mobile communication terminal may be used as the information on the vehicle position.

In each of the above-described embodiments, the display control unit 21 is exemplified as an example of the information providing unit, but in short, for example, the information may be provided by sound, voice, or any other notification means as long as the information relating to the drop-off available area can be provided to the user.

In the descriptions in each of the above embodiments, the vehicle return request is made by the user who is provided with and is riding on the autonomous driving vehicle 2, however, a user before being provided with the autonomous driving vehicle 2 may make the vehicle return request and may perform the input operation for the drop-off reservation application using a personal computer or a mobile communication terminal such as a tablet or a smartphone. In this case, for example, the information relating to the drop-off available area may be displayed on a display screen of a personal computer or a mobile communication terminal such as a tablet, or a smartphone instead of the display control unit 21.

In the example in FIG. 2, a plurality of autonomous driving allowable areas 3 are independent from each other, but the plurality of autonomous driving allowable areas 3 may overlap with each other. In this case, the drop-off available area specifying units 33 and 27 may specify an overlapping area in which the plurality of autonomous driving allowable areas 3 overlap, as the drop-off available area. For example, if the scheduled vehicle return location included in the drop-off reservation application is within the overlapping area, the drop-off available area specifying units 33 and 27 may specify the autonomous driving allowable area 3 associated with the parking station 10 having a closer distance to the scheduled vehicle return location, as the drop-off available area.

What is claimed is:

1. An autonomous driving vehicle management system for providing a user with an autonomous driving vehicle that is capable of autonomous driving at a plurality of autonomous driving allowable areas respectively associated with a plurality of parking stations, the system comprising:
a vacancy situation acquisition unit configured to acquire a vacancy situation at the parking stations;
a drop-off available area specifying unit configured to specify a drop-off available area where the autonomous driving vehicle can be dropped off based on the vacancy situation acquired by the vacancy situation acquisition unit and the autonomous driving allowable area;
an information providing unit configured to provide the user with information relating to the drop-off available area specified by the drop-off available area specifying unit.

2. The autonomous driving vehicle management system according to claim 1, further comprising:
a position recognition unit configured to recognize a vehicle position of the autonomous driving vehicle,
wherein the drop-off available area specifying unit is configured to acquire information on a distance to empty of the autonomous driving vehicle on which the user is riding, and to specify the drop-off available area based on the vacancy situation, the autonomous driving allowable area, the vehicle position, and the information on the distance to empty.
